(19) United States
(12) Patent Application Publication
(10) Pub. No.: US 2022/0144236 A1
(43) Pub. Date: May 12, 2022

(54) APPARATUS FOR ELECTRIC HYDRAULIC BRAKE

(71) Applicant: HYUNDAI MOBIS CO., LTD., Seoul (KR)

(72) Inventor: Chang Hoe KOO, Anyang-si (KR)

(21) Appl. No.: 17/136,707

(22) Filed: Dec. 29, 2020

(30) Foreign Application Priority Data
Nov. 6, 2020 (KR) 10-2020-0147299

(51) Int. Cl. B60T 13/68; B60T 13/66; B60T 8/40

(52) U.S. Cl. CPC B60T 13/686; B60T 8/4081; B60T 13/662

(57) ABSTRACT

The present disclosure in some embodiments provides an apparatus for electric hydraulic braking including a reservoir, a backup master cylinder, a motor, a main master cylinder, wheel brakes each generating a braking force on each wheel, an ECU for generating the motor control signal and a valve control signal for the wheel brakes to form a braking force based on the brake pedal effort, and a hydraulic circuit valve device including a backup valve operable, based on the valve control signal, to change a flow path of fluid flowing internally of the hydraulic circuit valve device and to open and close a backup flow path between the backup master cylinder and main master cylinder, wherein when performing a hydraulic pressure dropping of the brake fluid inside the hydraulic circuit valve device, the electronic control unit opens the backup valve to allow the brake fluid discharged from the main master cylinder to be recovered to the reservoir through a brake flow path.

### CROSS-REFERENCE TO RELATED APPLICATIONS

This application is based on, and claims priority from, Korean Patent Application Number 10-2020-0147299, filed Nov. 6, 2020, the disclosure of which is incorporated by reference herein in its entirety.

### TECHNICAL FIELD

The present disclosure in some embodiments relates to an apparatus for electric hydraulic braking.

### BACKGROUND

The statements in this section merely provide background information related to the present disclosure and do not necessarily constitute prior art.

A conventional electric hydraulic brake system adjusts the braking pressure of each wheel by using a hydraulic modulator upon detecting the pedal pressure of the driver through a sensor. The electric hydraulic brake system includes a sensor for detecting the stroke distance of the pedal to know the driver's desired braking pressure and a pedal simulator for enabling the driver to feel the same pedal pressure as with a typical hydraulic brake system. The system also includes a control unit that determines the driver's required braking force through means such as a pedal stroke sensor and a pressure sensor and drives a separate wheel brake mechanism to generate braking force to wheel brakes. The wheel brake mechanism generally includes a main master cylinder structure for forming hydraulic pressure and a hydraulic circuit and valves for transmitting the hydraulic pressure formed by the main master cylinder to the vehicle wheel brakes.

However, the wheel brake mechanism includes a plurality of solenoid valves for transmitting the hydraulic pressure formed by the master cylinder to the wheel brakes, and the more solenoid valves are included, the more complicated the structure of the electric hydraulic brake system.

Despite their infrequent operative engagement, some solenoid valves are required to be included in the wheel brake mechanism for use in a specific mode, which incurs a higher manufacturing cost and a heavier weight of the electric hydraulic brake system.

### SUMMARY

According to at least one embodiment, the present disclosure provides an apparatus for electric hydraulic braking, including a reservoir configured to store brake fluid, a backup master cylinder, a motor, a main master cylinder, a plurality of wheel brakes, an electronic control unit (ECU), and a hydraulic circuit valve device. The backup master cylinder is configured to be responsive to a brake pedal effort for changing the pressure of the brake fluid inside the backup master cylinder. The motor is configured to generate a rotational output based on a motor control signal. The main master cylinder includes a main piston configured to move forward or backward in association with the rotational output of the motor and to change the pressure of the brake fluid inside the main master cylinder. The wheel brakes are each configured to generate a braking force on each of the wheels. The electronic control unit (ECU) is configured to generate the motor control signal and a valve control signal for the wheel brakes to form a braking force based on the brake pedal effort. The hydraulic circuit valve device includes a backup valve configured to be operable, based on the valve control signal, to change a flow path of fluid flowing internally of the hydraulic circuit valve device and to open and close a backup flow path between the backup master cylinder and the main master cylinder. Here, the electronic control unit is responsive to when performing a hydraulic pressure dropping of the brake fluid inside the hydraulic circuit valve device for opening the backup valve to allow the brake fluid that is discharged from the main master cylinder to be recovered to the reservoir through a brake flow path.

### BRIEF DESCRIPTION OF THE DRAWINGS

FIG. 1 is a block diagram showing a hydraulic circuit of an electric hydraulic brake according to at least one embodiment of the present disclosure.

FIG. 2 is a block diagram of the electric hydraulic brake according to at least one embodiment in a low-pressure dropping mode, illustrating a flow of brake fluid and opening/closing states of solenoid valves.

FIG. 3 is a block diagram of an electric hydraulic brake according to another embodiment in a low-pressure dropping mode, illustrating a flow of brake fluid and opening/closing states of solenoid valves.

FIG. 4 is a block diagram of the electric hydraulic brake according to at least one embodiment in a high-pressure dropping mode, illustrating a flow of brake fluid and opening/closing states of the solenoid valves.

FIG. 5 is a block diagram of the electric hydraulic brake according to another embodiment in a high-pressure dropping mode, illustrating a flow of brake fluid and opening/closing states of the solenoid valves.

FIG. 6 is a block diagram of the electric hydraulic brake according to at least one embodiment having a second brake flow path in a fault condition, illustrating a flow of brake fluid and opening/closing states of the solenoid valves.

FIG. 7 is a block diagram of the electric hydraulic brake according to another embodiment having a second brake flow path in a fault condition, illustrating a flow of brake fluid and opening/closing states of the solenoid valves.

REFERENCE NUMERALS

| | |
|---|---|
| 110: backup master cylinder | 120: main master cylinder |
| 140: control unit | 150: actuator |
| 161, 163: brake flow path | 162, 164, 166 and 168: return |
| | flow path |
| 165b, 165a: main flow path | |
| 171, 172, 173, 174, 175, 176: | |
| backup flow path | |
| 181, 182, 183, 184: inlet valve | 185, 186, 187, 188: outlet valve |
| 191, 192: traction control valve | 193: mixing valve |
| 194, 195, 196, 197: backup valve | |
| w1, w2, w3, and w4: multiple | |
| wheel brakes | |

### DETAILED DESCRIPTION

Accordingly, the electric hydraulic brake apparatus according to at least one embodiment of the present disclosure seeks to delete solenoid valves that are used only in a specific mode and have a low operating frequency and to employ a backup valve and an outlet valve to perform the capacity of the deleted solenoid valves in their place to reduce the number of solenoid valves inside the electric hydraulic brake apparatus, thereby lightening the electric hydraulic brake apparatus.

Some exemplary embodiments of the present disclosure are described below with reference to the accompanying drawings. In the following description, like reference numerals preferably designate like elements, although the elements are shown in different drawings. Further, in the following description of some embodiments, a detailed description of known functions and configurations incorporated herein will be omitted for the purpose of clarity and for brevity.

Alphanumeric codes such as first, second, i), ii), a), b), etc., in describing components of embodiments of the present disclosure are used solely for the purpose of differentiating one component from the other but not to imply or suggest the substances, the order, or sequence of the components. Throughout this specification, when a part “includes” or “comprises” a component, the part is meant to further include other components, not excluding thereof unless there is a particular description contrary thereto.

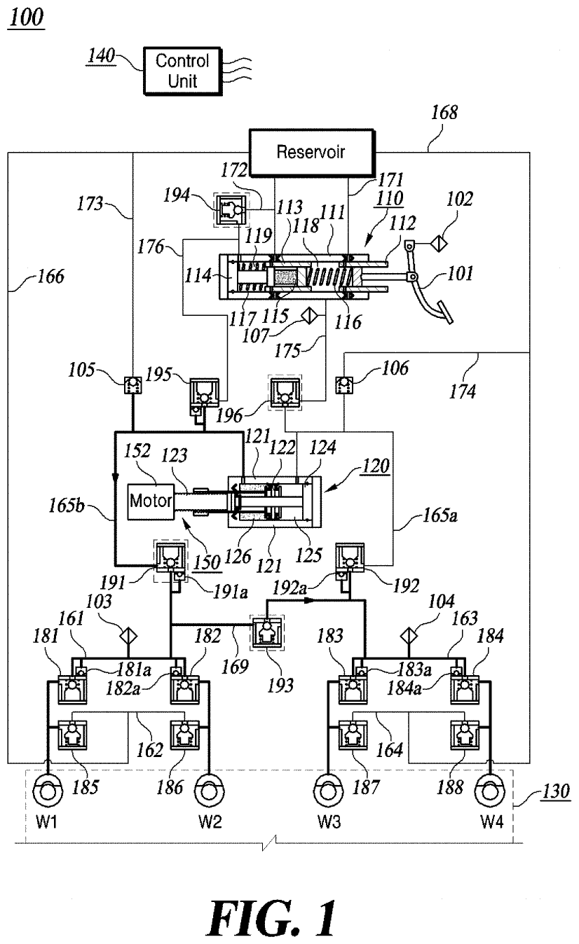

FIG. 1 is a block diagram showing a hydraulic circuit of an electric hydraulic brake according to at least one embodiment of the present disclosure.

As shown in FIG. 1, the vehicle brake apparatus according to at least one embodiment of the present disclosure includes a backup master cylinder 110, a main master cylinder 120, wheel brakes w1, w2, w3, and w4, a control unit 140, an actuator 150, and a plurality of solenoid valves and flow paths.

The backup master cylinder 110 includes a backup body 111, a first backup piston 112, a second backup piston 113, a backup stopper 114, a reaction damper 115, a first elastic member 116, and a second elastic member 117.

The backup body 111 is formed into a hollow structure. In the internal space of the backup body 111, the first backup piston 112 and the second backup piston 113 are arranged to be linearly moved left and right. The internal space of the backup body 111 is divided into a first backup chamber 118 which corresponds to the space that is between the first backup piston 112 and the second backup piston 113, and a second backup chamber 119 which corresponds to the space that is between the second backup piston 113 and the backup stopper 114.

The backup body 111 has its left end and right end open. Inserted into the open right end of the backup body 111 is the left end of the first backup piston 112 which then closes the open right end of the backup body 111. Protruding from the right end of the backup body 111 is the right end of the first backup piston 112, and the brake pedal 101 is connected to the protruding right end of the first backup piston 112. On the brake pedal 101, a stroke sensor 102 may be installed for detecting a stroke of the brake pedal 101 when the driver depresses the brake pedal 101. The first backup piston 112 is installed to be linearly moved left and right while in close contact with the inner wall of the backup body 111.

Inserted into the open left end of the backup body 111 is the right end of the backup stopper 114 which then closes the open left end of the backup body 111.

The second backup piston 113 is installed internally of the backup body 111 to be linearly movable left and right while in close contact with the inner wall of the backup body 111. The second backup piston 113 is disposed to be spaced apart from the first backup piston 112 and the backup stopper 114. Between the first backup piston 112 and the second backup piston 113 that are spaced apart, the first elastic member 116 is disposed. The first elastic member 116 is formed of a spring element, having one end that elastically supports the first backup piston 112 and the other end that elastically supports the second backup piston 113. Between the second backup piston 113 and the backup stopper 114 that are spaced apart, the second elastic member 117 is disposed. The second elastic member 117 is formed of a spring element, having one end that elastically supports the second backup piston 113 and the other end that elastically supports the backup stopper 114.

The second backup piston 113 is formed as a hollow structure, having a blind right side toward the first backup piston 112 and an open left side toward the backup stopper 114.

The backup stopper 114 penetrates through the second elastic member 117, having its right end inserted into and seated in the open left end of the second backup piston 113.

The reaction damper 115 is disposed inside the second backup piston 113 and has one end that is supported by the right end of the backup stopper 114 and the other end that is supported by the right side of the second backup piston 113. The reaction damper 115 is compressed when the second backup piston 113 is moved to the left so that the driver gets the feel of a reaction due to stepping on the brake pedal 101. In this embodiment, the reaction damper 115 is formed of rubber for allowing the driver to feel the reaction force due to stepping on the brake pedal 101 by the elastic restoring force of the rubber.

The main master cylinder 120 is driven by a motor 152 controlled by the control unit 140 to generate and supply hydraulic pressure to the wheel brakes w1, w2, w3, and w4. Here, the control unit 140 may be an electronic control unit (ECU), which is a typical vehicle control device. When the driver steps on the brake pedal 101, the stroke sensor 102 detects and transmits the stroke of the brake pedal 101 to the control unit 140 which then controls the motor 152 based on the detected stroke of the brake pedal 101 from the stroke sensor 102, thereby controlling the hydraulic pressure generated by the main master cylinder 120. Here, the motor 152 is a driving motor that provides power for the main piston 122 to advance and generate hydraulic pressure to the main master cylinder 120.

The main master cylinder 120 includes a main body 121, a main piston 122, a rod 123, and a main stopper 124.

The main body 121 is formed into a hollow structure. In the inner space of the main body 121, the main piston 122 is arranged to be linearly movable left and right. The internal space of the main body 121 is divided by the main piston 122 into two that consist of a first main chamber 125 disposed on the right side with respect to the main piston 122 and a second main chamber 126 which is a space disposed on the left side from the main piston 122.

In the present specification, the terms ‘left’ and ‘right’ are merely used for indicating directions in which certain elements are shown in the drawings, and the present disclosure is not limited to their directions and positions of arrangement.

The main piston 122 that advances to the right widens the second main chamber 126 and narrows the first main chamber 125. Conversely, the main piston 122 that retreats to the left narrows the second main chamber 126 and widens the first main chamber 125.

The main body 121 is opened at the left end and the right end thereof. In the main body 121, the right end is completely open, and the left end is partially opened. A rod 123 is provided with its right end inserted into the open left end of the main body 121. The rod 123 has its right end connected to the main piston 122 inside the main body 121. The rod 123 may be integrally formed with the main piston 122.

The main piston 122 and the rod 123 are formed to have different diameters so that the main piston 122 is larger in diameter than the rod 123 that is thinner.

The left end of the rod 123 is protruding to the left of the main body 121, and the protruding left end of the rod 123 is installed with an actuator 150 for linearly moving the rod 123 left and right.

The actuator 150 includes a motor 152 and a female screw and a male screw for converting the rotational torque of the motor 152 into linear motion to move the rod 123 in a straight line to the left and right. The female screw has an inner circumferential surface formed with a helix. Further, the female screw is coupled to the left end of the rod 123. The male screw has an outer circumferential surface formed with a helix that meshes with the helix of the female screw and is inserted into the female screw. The male screw is connected to the rotor shaft of the motor 152 and corotates with the rotor shaft of the motor 152 when rotated, thereby linearly moving the female screw along with the rod 123, and accordingly moving the main piston 122 straight to the left or right.

Inserted into the open right end of the main body 121 is the left end of the main stopper 124 for closing that open right end of the main body 121.

Within the internal space of the main body 121, the main piston 122 is installed to be able to linearly move left and right while in close contact with the inner walls of the main body 121. The main piston 122 has its outer circumferential surface disposed to be centrally in close contact with and distally spaced apart from the inner walls of the main body 121. The main piston 122 has a hollow center, and the rod 123 has a hollow center. The male screw penetrates the female screw and has its right end disposed inside the rod 123. The main stopper 124 penetrates the main piston 122 and has its left end inserted into and seated in the rod 123.

The second main chamber 126 has the main piston 122 and the rod 123 are disposed therein, but the first main chamber 125 has not the rod 123 but the main piston 122 alone disposed therein. Therefore, when the main piston 122 advances to the right, the effective cross-sectional area of the first main chamber 125 that compresses the brake fluid therein is formed to be larger than the effective cross-sectional area of the second main chamber 126 that compresses the brake fluid therein when the main piston 122 retreats to the left.

The control unit 140 generates a motor control signal for controlling the motor 152 to allow the main master cylinder 120 to generate hydraulic pressure, and it generates a valve control signal for a hydraulic circuit valve device to open or close a plurality of solenoid valves therein. In the detailed description of the present disclosure, the hydraulic circuit valve device is termed as encompassing a plurality of solenoid valves shown in FIG. 1.

The wheel brakes w1, w2, w3, and w4 include a first wheel brake (w1) for braking the front left vehicle wheel, a second wheel brake w2 for braking the rear right vehicle wheel, a third wheel brake w3 for braking the rear left vehicle wheel, and a fourth wheel brake w4 for braking the front right vehicle wheel.

Between the backup master cylinder 110, the main master cylinder 120, and the wheel brakes w1, w2, w3, and w4 configured as described above, there are interrelations as follows.

The first wheel brake w1 and the second wheel brake w2 are connected to a first brake flow path 161. In particular, the first brake flow path 161 is branched so that one end thereof is connected to the first wheel brake w1, and the other end thereof is connected to the second wheel brake w2.

The first brake flow path 161 is installed with a first inlet valve 181 and a second inlet valve 182 for opening and closing the first brake flow path 161. The first inlet valve 181 is disposed adjacent to the first wheel brake w1, and the second inlet valve 182 is disposed adjacent to the second wheel brake w2.

The first inlet valve 181 is provided with a check valve 181a for preventing reverse flow of the brake fluid, and the second inlet valve 182 is also provided with a check valve 182a for preventing reverse flow of the brake fluid.

The first brake flow path 161 is provided with a first pressure sensor 103 that measures the pressure of the brake fluid in the first brake flow path 161. In particular, the first pressure sensor 103 is installed in the first brake flow path 161 that spans between the first inlet valve 181 and the second inlet valve 182.

To the first brake flow path 161 that spans between the first wheel brake w1 and the first inlet valve 181, a first return flow path 162 is connected by its branched one end. Additionally, the branched other end of the first return flow path 162 is connected to the first brake flow path 161 that spans between the second wheel brake w2 and the second inlet valve 182.

The first return flow path 162 is installed with a first outlet valve 185 and a second outlet valve 186 for opening and closing the first return flow path 162. The first outlet valve 185 is disposed adjacent to one end of the first return flow path 162, and the second outlet valve 186 is disposed adjacent to the other end of the first return flow path 162.

The third wheel brake w3 and the fourth wheel brake w4 are connected to a second brake flow path 163. In particular, the second brake flow path 163 is branched so that one end thereof is connected to the third wheel brake w3, and the other end thereof is connected to the fourth wheel brake w4.

The second brake flow path 163 is installed with a third inlet valve 183 and a fourth inlet valve 184 for opening and closing the second brake flow path 163. The third inlet valve 183 is disposed adjacent to the third wheel brake w3, and the fourth inlet valve 184 is disposed adjacent to the fourth wheel brake w4.

The third inlet valve 183 is provided with a check valve 183a for preventing reverse flow of the brake fluid, and the fourth inlet valve 184 is also provided with a check valve 184a for preventing reverse flow of the brake fluid.

The second brake flow path 163 is provided with a second pressure sensor 104 that measures the pressure of the brake fluid in the second brake flow path 163. In particular, the second pressure sensor 104 is installed in the second brake flow path 163 that spans between the third inlet valve 183 and the fourth inlet valve 184.

To the second brake flow path 163 that spans between the third wheel brake w3 and the third inlet valve 183, a second return flow path 164 is connected by its branched one end. Additionally, the branched other end of the second return flow path 164 is connected to the second brake flow path 163 that spans between the fourth wheel brake w4 and the fourth inlet valve 184. The second return flow path 164 is installed with a third outlet valve 187 and a fourth outlet valve 188 for opening and closing the second return flow path 164. The third outlet valve 187 is disposed adjacent to one end of the second return flow path 164, and the fourth outlet valve 188 is disposed adjacent to the other end of the second return flow path 164.

To the second main chamber 126 of the main master cylinder 120, a second main flow path 165b is connected by its one end. In particular, the second main flow path 165b has one end connected to the main body 121 to be in fluid communication with the second main chamber 126 of the main master cylinder 120. The other end of the second main flow path 165b is connected via a first traction control valve 191 to the first inlet valve 181 and the second inlet valve 182 in the first brake flow path 161.

The second main flow path 165b is installed with a first traction control valve 191 for opening and closing the second main flow path 165b. The first traction control valve 191 is a solenoid valve that is controlled by the control unit 140 to open and close the second main flow path 165b. The first traction control valve 191 may be installed in the flow path for supplying hydraulic pressure of the second main chamber 126 to the wheel brakes w1, w2, w3, and w4. The first traction control valve 191 is installed with a check valve 191a. The check valve 191a is opened when the hydraulic pressure in the second main chamber 126 is higher than a certain pressure to bypass the hydraulic pressure in the second main chamber 126 to be supplied to the wheel brakes w1, w2, w3, and w4 while the first traction control valve 191 is closed.

To the first main chamber 125 of the main master cylinder 120, a first main flow path 165a is connected by its one end. In particular, the first main flow path 165a has one end connected to the main body 121 to be in fluid communication with the first main chamber 125 of the main master cylinder 120. The other end of the first main flow path 165a is connected via a second traction control valve 192 to the third inlet valve 183 and the fourth inlet valve 184 in the second brake flow path 163.

The first main flow path 165a is installed with a second traction control valve 192 for opening and closing the first main flow path 165a. The second traction control valve 192 is a solenoid valve that is controlled by the control unit 140 to open and close the first main flow path 165a. The second traction control valve 192 may be installed in the flow path for supplying hydraulic pressure of the first main chamber 125 to the wheel brakes w1, w2, w3, and w4. The second traction control valve 192 is installed with a check valve 192a. The check valve 192a is opened when the hydraulic pressure in the first main chamber 125 is higher than a certain pressure to cause the hydraulic pressure in the first main chamber 125 to bypass toward the wheel brakes w1, w2, w3, and w4 while the second traction control valve 192 is closed.

Within the second main flow path 165b, a mixing flow path 169 is connected at its one end to a node between the first traction control valve 191 and the first brake flow path 161. Additionally, within the main flow path 165a, the other end of the mixing flow path 169 is connected to a node between the second traction control valve 192 and the second brake flow path 163. The mixing flow path 169 is provided with a mixing valve 193 that opens and closes the mixing flow path 169.

The first backup chamber 118 of the backup master cylinder 110 is connected with one end of the first backup flow path 171 which has its other end connected to the second backup chamber 119. In particular, the first backup flow path 171 has one end connected to the backup body 111 of the backup master cylinder 110 to be in fluid communication with the first backup chamber 118, and it has the other end connected to the backup body 111 to be in fluid communication with the second backup chamber 119. In the first backup flow path 171, a reservoir is installed for storing brake fluid.

Connected to the reservoir is one end of a third return flow path 166. The other end of the third return flow path 166 is connected to the first return flow path 162 that spans between the first outlet valve 185 and the second outlet valve 186.

Further connected to the reservoir is one end of a fourth return flow path 168. The other end of the fourth return flow path 168 is connected to the second return flow path 164 that spans between the third outlet valve 187 and the fourth outlet valve 188.

The backup master cylinder 110 is also connected to the reservoir using a second backup flow path 172.

Connected to the second backup chamber 119 is the second backup flow path 172 by one end thereof. Namely, the second backup passage 172 has one end connected to the second backup chamber 119 and the other end connected to the first backup passage 171 that spans between the reservoir and the backup body 111.

A first backup valve 194 is installed in the second backup flow path 172 for opening and closing thereof.

A third backup flow path 173 is provided with one end thereof connected to the reservoir, having the other end thereof connected to the second main flow path 165b. The third backup flow path 173 is installed with a check valve 105 to prevent the reverse flow of the brake fluid.

A fourth backup flow path 174 is provided with a check valve 106 installed therein to prevent the reverse flow of the brake fluid.

The fourth backup passage 174 has one end connected to the fourth return flow path 168 and the other end connected to the first main chamber 125 of the main master cylinder 120 by using the check valve 106.

Connected also to the first backup chamber 118 is one end of a fifth backup flow path 175. In particular, the fifth backup flow path 175 has one end connected to the backup body 111 to be in fluid communication with the first backup chamber 118. Further, the fifth backup flow path 175 has the other end connected to the main body 121 of the main master cylinder 120. A third backup valve 196 is installed in the fifth backup flow path 175 for opening and closing thereof. A third pressure sensor 107 is further installed in the fifth backup flow path 175 for measuring the pressure of the brake fluid therein. In other words, the third pressure sensor 107 is installed in the fifth backup flow path 175 that spans between the backup body 111 of the backup master cylinder 110 and the third backup valve 196.

Connected also to the second backup chamber 119 of the backup master cylinder 110 is one end of a sixth backup flow path 176. The sixth backup flow path 176 has one end connected to the backup body 111 to be in fluid communication with the second backup chamber 119. Further, the sixth backup flow path 176 has the other end connected to the second main flow path 165b that is between one end thereof and the other end of the third backup flow path 173. A second backup valve 195 is installed in the sixth backup flow path 176 for opening and closing thereof.

Composed of solenoid valves controlled by the controller 140 are the aforementioned components including the first inlet valve 181 to the fourth inlet valve 184, the first outlet valve 185 to the fourth outlet valve 188, the first traction control valve 191, the second traction control valve 192, the mixing valve 193, the first backup valve 194, and the second backup valve 195.

The first inlet valve 181, second inlet valve 182, third inlet valve 183, and fourth inlet valve 184 are formed in a normally open type for they are normally open when no control signal is inputted from the control unit 140.

Whereas, the first outlet valve 185, second outlet valve 186, third outlet valve 187, and fourth outlet valve 188 are formed in a normally closed type for when no control signal is inputted from the control unit 140.

The first traction control valve 191 and the second traction control valve 192 are formed of a normally open type for when no control signal is inputted from the control unit 140. Additionally, the mixing valve 193 is formed in a normally closed type for when no control signal is inputted from the control unit 140.

The first backup valve 194 is formed in a normally closed type for when no control signal is inputted from the control unit 140. Further, the second backup valve 195 and the third backup valve 196 are formed in a normally open type for when no control signal is inputted from the control unit 140.

When the brake of the vehicle is controlled by the control unit 140, the latter closes all of the fourth backup valve 197, third backup valve 196, and second backup valve 195. Then, since the first, second, third, and fourth backup valves 194, 195, 196, 197 are all closed, the flow path is blocked between the backup master cylinder 110 and the main master cylinder 120. Accordingly, in this case, the wheel brakes w1, w2, w3, and w4 generate braking force exclusively by hydraulic pressure supplied by the main master cylinder 120.

By the way, when no electric power is supplied to the control unit 140, the first backup valve 194 that is the normally closed type maintains a closed state, and the second backup valve 195 and the third backup valve 196, which are normally open type, remain open.

Therefore, in the non-power mode in which no power is supplied to the control unit 140, when the driver depresses the brake pedal 101, the hydraulic pressure, which formed in the second backup chamber 119 by receiving the brake fluid from the reservoir, is supplied to the first main chamber 125 by using the backup flow path 176.

Therefore, in the non-power mode in which the controller 140 is powerless, when the driver depresses the brake pedal 101, the hydraulic pressure, which is formed in the first backup chamber 118 by receiving the brake fluid from the reservoir, is transmitted to the node in the mixing flow path 169 between the mixing valve 193 and the second traction control valve 192 by using the backup flow path 175, and such hydraulic pressure is then transferred to the second brake flow path 163, thereby forming a braking force in the third brake w3 and the fourth brake w4.

Additionally, the hydraulic pressure, which is formed in the second backup chamber 119 by receiving the brake fluid from the reservoir, is transferred to the second main flow path 165b by using the sixth backup flow path 176, and such hydraulic pressure is then transferred to the succeeding first brake flow path 161, thereby forming a braking force in the first brake w1 and the second brake w2.

As such, with the brake apparatus of a vehicle according to at least one embodiment of the present disclosure, when the motor 152 is deenergized due to no power supplied to the control unit 140, the backup master cylinder 110 kicks in to supply the brake fluid to the main master cylinder 120 so that the main master cylinder 120 can generate sufficient hydraulic pressure to brake the plurality of wheel brakes w1, w2, w3, and w4 even when the motor 152 is not operated.

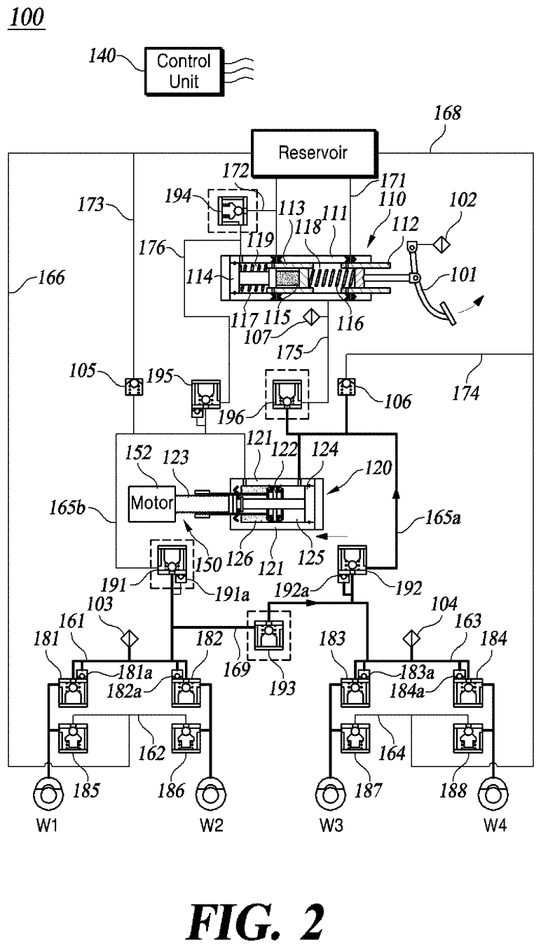

FIG. 2 is a block diagram of the electric hydraulic brake according to at least one embodiment in a low-pressure dropping mode, illustrating a flow of brake fluid and opening/closing states of solenoid valves.

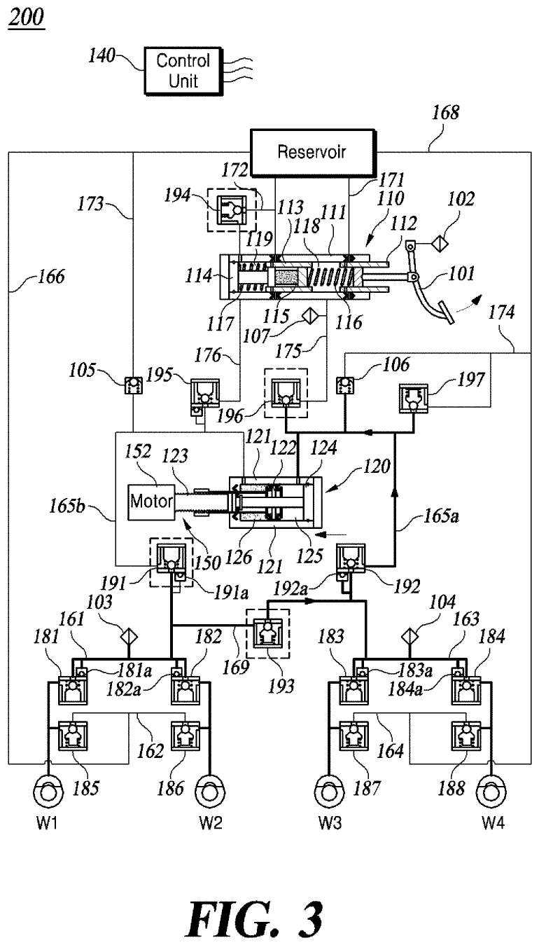

FIG. 3 is a block diagram of an electric hydraulic brake according to another embodiment in a low-pressure dropping mode, illustrating a flow of brake fluid and opening/closing states of solenoid valves.

In FIGS. 2 and 3, dotted-line squares on the solenoid valves represent those operated by receiving current from the control unit 140. On the other hand, the solenoid valves sans a dotted-line square represent those inoperative during a first-stage depressurization process.

In the detailed description of the present disclosure, the low-pressure dropping mode (or referred to as a first-stage depressurization process) represents a process in which the motor 152 rotates so that the main piston 122 retreats (to the left of the relevant drawings herein) and the brake fluid inside the first brake flow path 161 and the second brake flow path 163 is recovered to the first main chamber 125 via the first main flow path 165a.

On the other hand, the low-pressure boosting mode (or referred to as a first-stage boosting process) represents a process in which the motor 152 rotates so that the main piston 122 advances (to the right of the relevant drawings herein) and the brake fluid inside of the first main chamber 125 is discharged to the first brake flow path 161 and the second brake flow path 163 via the first main flow path 165a.

The fourth backup flow path 174 according to at least one embodiment of the present disclosure of FIG. 2 has one end connected to the fourth return flow path 168 and the other end connected to the first main chamber 125 of the main master cylinder 120 via the check valve 106.

On the other hand, the fourth backup flow path 174 according to another embodiment of the present disclosure of FIG. 3 has one end connected to the fourth return flow path 168 and the other end connected via the check valve 106 or a fourth backup valve 197 to the first main chamber 125 of the main master cylinder 120. The fourth backup valve 197 installed in the fourth backup flow path 174 for opening and closing thereof. Additionally, the fourth backup valve 197 is configured as a normally closed type valve. Therefore, in the non-power mode, when no valve control signal is applied to the fourth backup valve 197, the latter closes the fourth backup flow path 174 to block the flow path of the brake fluid between the first main chamber 125 and the fourth return flow paths 168.

In the first-stage depressurization process, no current is applied to the fourth backup valve 197 which is a normal close valve, so that the brake fluid inside the second brake flow path 163 does not pass through the fourth backup flow path 174. Accordingly, in the first-stage depressurization process, the embodiment that does not include the fourth backup valve 197 exhibits the same flow of the brake fluid as that of the another embodiment of the present disclosure including the fourth backup valve 197.

Likewise, in the first-stage boosting process, no current is applied to the fourth backup valve 197, which is a normally closed valve, so that the brake fluid inside the second brake flow path 163 does not pass through the fourth backup flow path 174. Likewise, in the first-stage boosting process, the embodiment that does not include the fourth backup valve 197 exhibits the same flow of the brake fluid as that of the another embodiment of the present disclosure including the fourth backup valve 197.

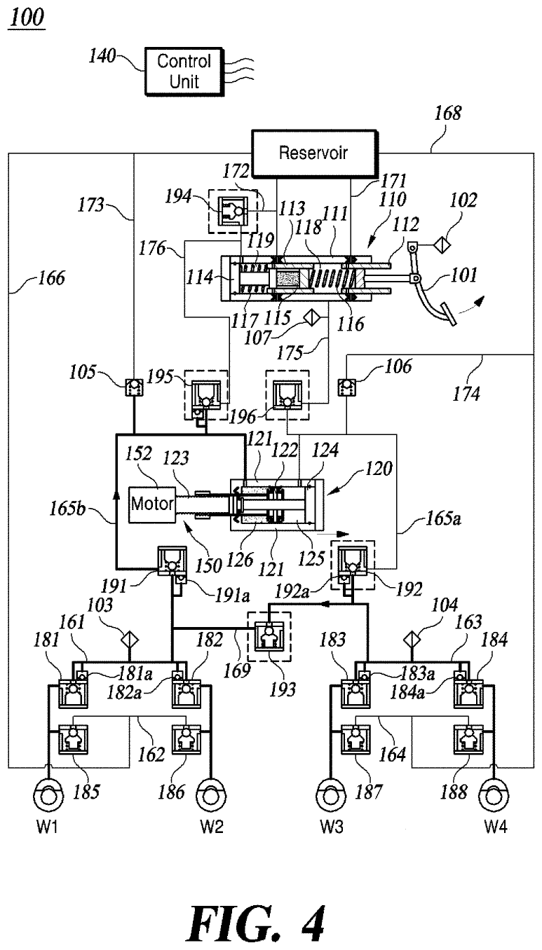

FIG. 4 is a block diagram of the electric hydraulic brake according to at least one embodiment in a high-pressure dropping mode, illustrating a flow of brake fluid and opening/closing states of the solenoid valves.

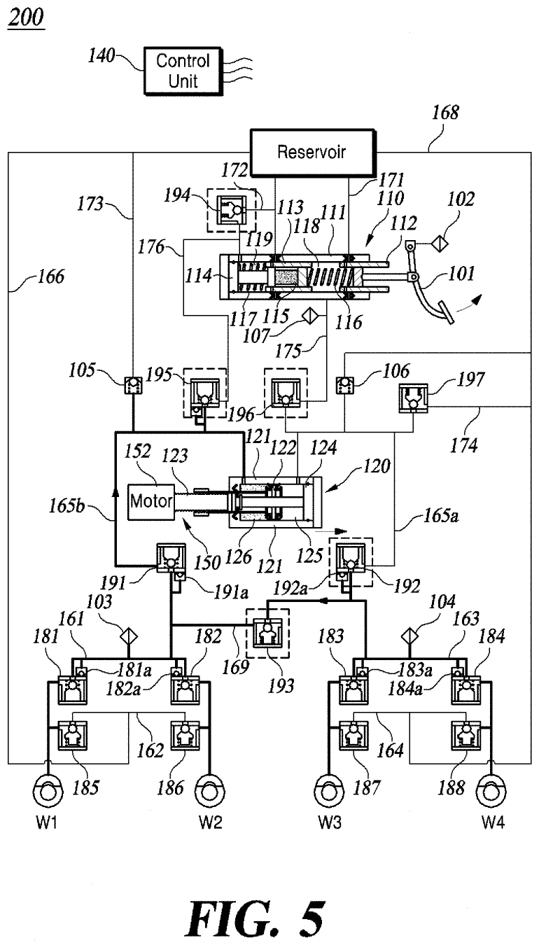

FIG. 5 is a block diagram of the electric hydraulic brake according to another embodiment in a high-pressure dropping mode, illustrating a flow of brake fluid and opening/closing states of the solenoid valves.

As shown in FIGS. 4 and 5, dotted-line squares on the solenoid valves represent those operated by receiving current from the control unit 140. On the other hand, the solenoid valves sans a dotted-line square represent those inoperative during a second-stage depressurization process.

In the detailed description of the present disclosure, the high-pressure dropping mode (or referred to as a second-stage depressurization process) refers to a process in which the motor 152 rotates so that the main piston 122 advances (to the right of the relevant drawings herein) and the brake fluid inside the first brake flow path 161 and the second brake flow path 163 is recovered to the second main chamber 126 via the second main flow path 165b.

On the other hand, the high-pressure boosting mode (or referred to as a second-stage boosting process) refers to a process in which the motor 152 rotates so that the main piston 122 retreats (to the left of the relevant drawings herein) and the brake fluid inside of the second main chamber 126 is discharged to the first brake flow path 161 and the second brake flow path 163 via the second main flow path 165b.

Unlike the first-stage depressurization process, in the second-stage depressurization process, the fourth backup valve 197 is opened by receiving current from the control unit 140. When the fourth backup valve 197 is opened, the brake fluid inside the first main chamber 125 of the main master cylinder 120 is recovered to the reservoir via the fourth return flow path 174. In the second-stage depressurization process, provided the fourth backup valve 197 is closed when the main piston 122 advances, the brake fluid inside the first main chamber 125 is supplied back via the first main flow path 165a to the second brake flow path 163, which does not drop the hydraulic pressure inside the hydraulic circuit. Therefore, the second depressurization process needs the fourth backup valve 197 to be opened.

However, the electric hydraulic brake according to at least one embodiment of the present disclosure, which does not include the fourth backup valve 197, drops the hydraulic pressure inside the hydraulic circuit by using the second backup valve 195 in the second-stage depressurization process.

The second backup valve 195 according to another embodiment of the present disclosure is configured as a normally open valve and is closed in the second-stage depressurization process by receiving current from the control unit 140.

On the other hand, the second backup valve 195 according to at least one embodiment of the present disclosure repeatedly opens or closes in the second-stage depressurization process and thereby allows some of the brake fluid that flows in the second main chamber 126 from the second main flow path 165b to be leaked into the sixth backup flow path 176 so that the leaked brake fluid is recovered to the reservoir. Therefore, even without the fourth backup valve 197, at least one embodiment of the present disclosure can utilize the second backup valve 195 for recovering the brake fluid discharged from the first main chamber 125.

Accordingly, at least one embodiment of the present disclosure has an effect of reducing the manufacturing cost of the hydraulic circuit and lightening the same by reducing the number of solenoid valves compared to other embodiments of the present disclosure.

Meanwhile, the second-stage boosting process, wherein the brake fluid in the first main flow path 165a is recovered to the first main chamber 125, can employ the another embodiment that includes the fourth backup valve 197 or the at least one embodiment without the fourth backup valve 197 in configuring the hydraulic circuit. Other than the presence or absence of the fourth backup valve 197, the solenoid valves may remain to be the same in configuration and function to implement the present disclosure.

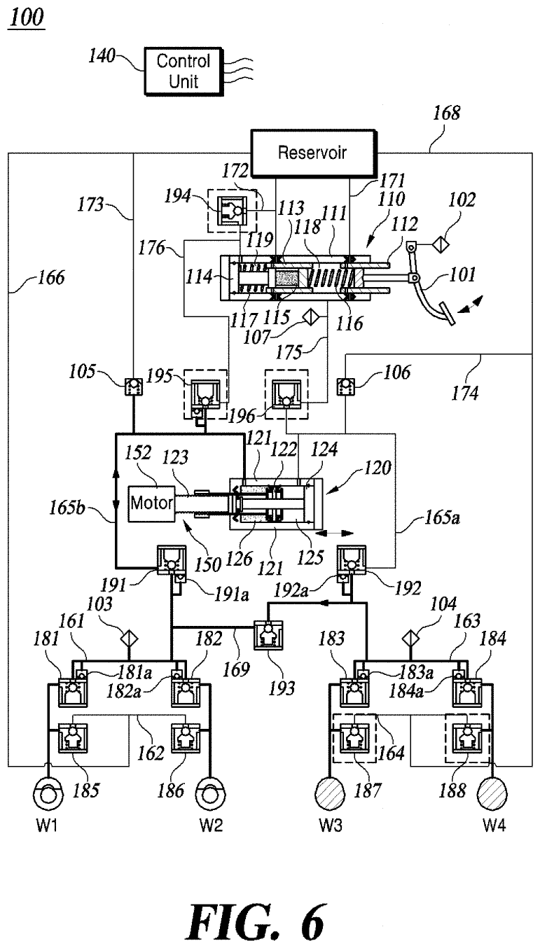

FIG. 6 is a block diagram of the electric hydraulic brake according to at least one embodiment having a second brake flow path in a fault condition, illustrating a flow of brake fluid and opening/closing states of the solenoid valves.

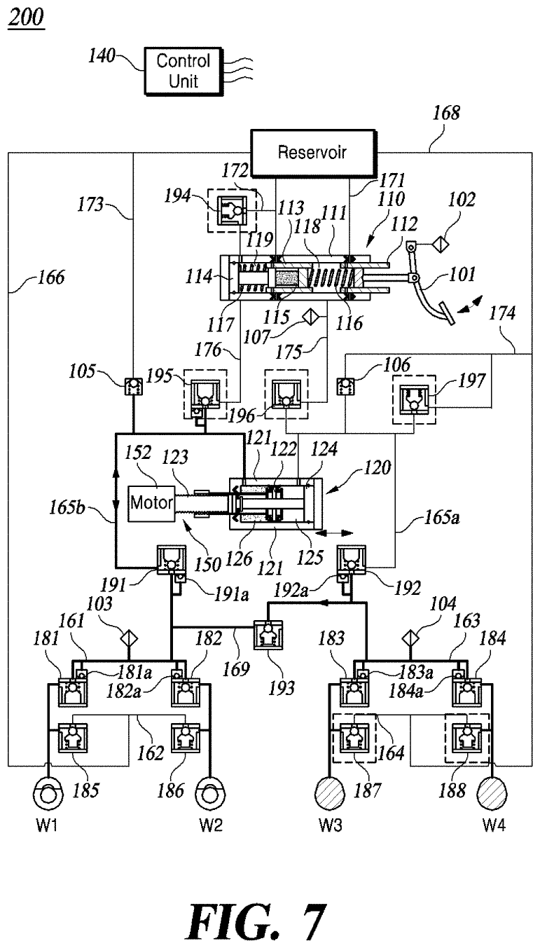

FIG. 7 is a block diagram of the electric hydraulic brake according to another embodiment having a second brake flow path in a fault condition, illustrating a flow of brake fluid and opening/closing states of the solenoid valves.

As shown in FIGS. 6 and 7, dotted-line squares on the solenoid valves represent those operated by receiving current from the control unit 140. On the other hand, the solenoid valves sans a dotted-line square represent those inoperative during a first-stage depressurization process. a square indicated by a dotted line on the solenoid valve means a solenoid valve that is operated by receiving current from the control unit 140. In addition, the third brake w3 and the second brake w4 indicated by hatching indicate a situation in which a failure occurs in the second brake flow path 163.

When a failure occurs in the second brake flow path 163 according to another embodiment of the present disclosure, the control unit 140 opens the fourth backup valve 197 and moves the main piston 122 forward or backward to render the brake fluid inside the first main chamber 125 to be recovered to the reservoir.

However, the electric hydraulic brake according to the at least one embodiment of the present disclosure, which does not include the fourth backup valve 197, is responsive to a failure occurring in the second brake flow path 163 for dropping the pressure in the hydraulic circuit by using the third outlet valve 187 and the fourth outlet valve 188.

The control unit 140 supplies current to the outlet valve 187 and the fourth outlet valve 188 configured as normally closed valves to open them. When the outlet valve 187 and the fourth outlet valve 188 are opened, the brake fluid inside the second brake flow path 163 passes through the outlet valve 187 and the fourth outlet valve 188 and the fourth return flow path 168 until it is recovered to the reservoir.

Therefore, when a failure occurs in the second brake flow path 163, the another embodiment of the present disclosure utilizes the fourth backup valve 197 for recovering the brake fluid inside the second brake flow path 163, and the at least one embodiment recovers the brake fluid inside the second brake flow path 163 by using the outlet valve 187 and the fourth outlet valve 188.

Accordingly, the at least one embodiment of the present disclosure needs fewer solenoid valves than the another embodiment, thereby reducing the manufacturing cost of the hydraulic circuit and lightening the hydraulic circuit.

On the other hand, a possible failure that occurs in the second brake flow path 163 is irrelevant to the operation of the fourth backup valve 197, the present disclosure can provide a hydraulic circuit configured in either the another embodiment that includes the fourth backup valve 197 or the at least one embodiment without the fourth backup valve 197. With or without the fourth backup valve 197, the solenoid valves may remain to be the same in configuration and function to implement the present disclosure.

As described above, according to some embodiments of the present disclosure, solenoid valves are deleted for being used only in a specific mode and having a low operating frequency, and a backup valve and an outlet valve are employed to perform the capacity of the deleted solenoid valves in their place to reduce the number of solenoid valves inside the electric hydraulic brake apparatus, thereby lightening the electric hydraulic brake apparatus.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

What is claimed is:

1. An apparatus for electric hydraulic braking, comprising:
a reservoir configured to store brake fluid;
a backup master cylinder configured to be responsive to a brake pedal effort for changing a pressure of the brake fluid inside the backup master cylinder;
a motor configured to generate a rotational output based on a motor control signal;
a main master cylinder comprising a main piston configured to move forward or backward in association with the rotational output of the motor and to change the pressure of the brake fluid inside the main master cylinder;
a plurality of wheel brakes each configured to generate a braking force on each of wheels;
an electronic control unit (ECU) configured to generate the motor control signal and a valve control signal for the wheel brakes to form a braking force based on the brake pedal effort; and
a hydraulic circuit valve device comprising a backup valve configured to be operable, based on the valve control signal, to change a flow path of fluid flowing internally of the hydraulic circuit valve device and to open and close a backup flow path between the backup master cylinder and the main master cylinder,
wherein the electronic control unit is responsive to when performing a hydraulic pressure dropping of the brake fluid inside the hydraulic circuit valve device for opening the backup valve to allow the brake fluid that is discharged from the main master cylinder to be recovered to the reservoir through a brake flow path.

2. The apparatus of claim 1, wherein
the main master cylinder comprises:
a first main chamber having an internal space that is narrowed toward where the main piston advances, and
a second main chamber having an internal space that is expanded toward where the main piston advances,
the backup master cylinder comprises:
a first backup chamber configured to supply the brake fluid to the first main chamber, and
a second backup chamber configured to supply the brake fluid to the second main chamber, and
the hydraulic circuit valve device comprises:
one or more main flow paths each configured to transmit a hydraulic pressure formed in the main master cylinder to the brake flow path, wherein
the apparatus further comprises:
a first traction control valve configured to open and close one of the main flow paths, and
a second traction control valve configured to open and close another one of the main flow paths.

3. The apparatus of claim 2, wherein
the main flow path comprises:
a first main flow path installed with the second traction control valve, and
a second main flow path installed with the first traction control valve,
the backup valve comprises:
a solenoid valve connected to the second main flow path, and
the electronic control unit is configured to control the backup valve to allow the brake fluid that is discharged to the first main flow path to be recovered to the reservoir through the second main flow path and thereby perform the hydraulic pressure dropping.

4. The apparatus of claim 3, wherein the backup valve comprises:
a normally open type valve.

5. The apparatus of claim 2, wherein
the first traction control valve comprises:
a normally open type valve, and
the second traction control valve comprises:
a normally open type valve.

6. The apparatus of claim 2, wherein
the hydraulic circuit valve device comprises:
a plurality of outlet valves configured to open and close a return flow path through which brake fluid that is supplied to the plurality of wheel brakes is recovered to the reservoir, and
the brake flow path is configured to distribute a hydraulic pressure inside the hydraulic circuit valve device to the plurality of wheel brakes, and to comprise:
a first brake flow path connected to the first traction control valve, and
a second brake flow path connected to the second traction control valve,
wherein
the electronic control unit is responsive to a failure when occurred in the second brake flow path for opening an outlet valve connected to the second brake flow path to recover the brake fluid to the reservoir.

7. The apparatus of claim 6, wherein
the hydraulic circuit valve device comprises:
a mixing valve configured to interconnect the first brake flow path and the second brake flow path, and to be opened based on the valve control signal for allowing the brake fluid inside the first brake flow path to be transmitted to the second brake flow path, and
the electronic control unit is responsive to a failure when occurred in the second brake flow path for opening the outlet valve to recover the brake fluid to the reservoir.

8. The apparatus of claim 7, wherein the mixing valve comprises:
a normally closed type valve.

9. The apparatus of claim 7, wherein the outlet valve comprises:
a normally closed type valve.
